(19) United States
(12) Patent Application Publication
(10) Pub. No.: US 2016/0189196 A1
(43) Pub. Date: Jun. 30, 2016

(54) REWARD SYSTEM USING REWARD MOBILE ADVERTISING APPLICATION

(71) Applicants: Soon Young HUH, Seoul (KR); KSOLVER Inc., Seoul (KR)

(72) Inventors: Soon Young HUH, Seoul (KR); Doo Young KIM, Bucheon-si (KR)

(73) Assignees: KSOLVER INC., Seoul (KR); Soon Young HUH, Seoul (KR)

(21) Appl. No.: 14/588,502

(22) Filed: Jan. 2, 2015

(30) Foreign Application Priority Data
Dec. 31, 2014 (KR) 10-2014-0195756

(51) Int. Cl. G06Q 30/02

(52) U.S. Cl. CPC G06Q 30/0231; G06Q 30/0267

(57) ABSTRACT

There is provided a system for rewarding economic activities in a virtual space using a reward-based mobile advertising application. The system forms the virtual organization with a plurality of branches, manages the virtual organization and an organizational structure on a branch unit basis, changes a number of branches according to the number of members, limits a number of members belonging to each branch, and limits a number of members at each position. In addition, the system evaluates performance of the members based on a performance-related activity criteria, and evaluates loyalty of the members based on a loyalty-related activity criteria. Further, the system rewards each member according to a result of the evaluated performance and loyalty thereof.

### CROSS-REFERENCE TO RELATED APPLICATION(S)

This application claims priority from Korean Patent Application No. 10-2014-0195756, filed on Dec. 31, 2014, in the Korean Intellectual Property Office, the disclosure of which is incorporated herein by reference in its entirety.

### BACKGROUND

1. Field

The following description relates to an advertising platform and, in particular, to an advertising platform using a reward-based mobile advertising application.

2. Description of the Related Art

A reward-based mobile advertising application, also known as a rewards app, refers to an application that rewards a user a point or cash when the user looks at an advertisement or conducts a particular mission. As smart phones are widely used, advertisers need a platform for effectively advertising service products which they can do by exploiting smart phones. Combined with the idea of rewarding a user for viewing an advertisement with some of advertising fees, the need of the advertisers has prompted development of rewards apps. The reward app has opened a new platform of advertising and is an area in which much investment and research is constantly being made.

### SUMMARY

The following description relates to a system that motivates members of a rewards app to conduct more activities and vitalizes a reward-based advertising platform.

In one general aspect, there is provided a system for rewarding economic activities in a virtual space using a reward-based mobile advertising application, wherein a virtual organization is made up of members of the reward-based mobile advertising application and the economic activities are conducted by the members, the system including: an organization manager configured to form the virtual organization with a plurality of branches, manage the virtual organization and an organizational structure on a branch unit basis, change a number of branches according to the number of members, limit the number of members belonging to each branch, and limit a number of members at each position; a performance evaluator configured to evaluate performance of the members based on a performance-related activity criteria that comprises at least one of installing an advertising app, executing the installed advertising app, or reviewing the installed advertising app; a loyalty evaluator configured to evaluate loyalty of the members based on a loyalty-related activity criteria comprising at least one of the following: attendance, viewing an advertisement, installing an advertising app, executing the installed advertising app, or reviewing the installed advertising app and at least some of the following: recommending a new member, posting in a community, registering a survey, or a replying to a post; and an evaluation rewarder configured to reward each member according to a result of the evaluated performance and loyalty thereof.

The reviewing of the installed advertising app may be confirmed with a capture image.

The loyalty evaluator may be further configured to give appraisal points to the members according to the loyalty-related activities thereof, determine hierarchical positions of the members according to the appraisal points, and rank members who are in the same positions according to the appraisal points.

The evaluation rewarder may be further configured to comprise: a performance rewarder configured to provide a member with incentives each time a performance-related activity of the member is confirmed; and a loyalty rewarder configured to provide additional incentives differently according to a total amount of incentives of each branch, wherein the additional incentives of each branch is provided to members differently according to positions thereof.

The loyalty evaluator may be further configured to accumulate the appraisal points and deduct some of the appraisal points at predetermined time intervals.

The loyalty rewarder may be further configured to provide the additional incentives according to a total amount of incentives earned on a daily basis, wherein the additional incentives are provided only when requirements for additional incentives are satisfied.

The loyalty rewarder may be further configured to divide the total amount of incentives of each branch into a number of positions and divide an amount of incentives for each position by a number of members in the same position so that the members in each position are provided with an equal amount of incentives.

The organization manager may be further configured to authorize board members to monitor and report loyalty-related activities of the members. Other features and aspects will be apparent from the following detailed description, the drawings, and the claims.

### BRIEF DESCRIPTION OF THE DRAWINGS

FIG. 1 is a block diagram illustrating a system for rewarding economic activities in a virtual space using a reward-based mobile advertising application according to an exemplary embodiment.

FIG. 2 is a block diagram illustrating a reward-based advertising platform server according to an exemplary embodiment.

FIGS. 3 and 4 are diagrams illustrating a user interface on which the category “Employee Card” of a reward app has been selected, according to an exemplary embodiment.

FIG. 5 is a diagram illustrating a user interface on which a salary status has been selected, according to an exemplary embodiment.

FIGS. 6, 7, and 8 are diagrams illustrating a user interface on which the category “Office” of a reward app has been selected, according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

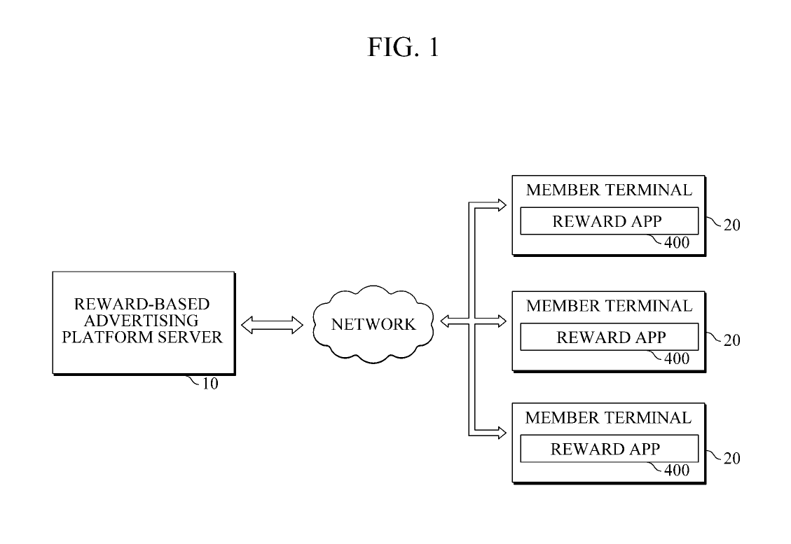

FIG. 1 is a block diagram illustrating a system for rewarding economic activities in a virtual space using a reward-based mobile advertising application according to an exemplary embodiment. A system for rewarding economic activities in a virtual space using a reward-based mobile advertising application (hereinafter, referred to as “rewards system”) includes a reward-based advertising platform server 10. The rewards system may consist of only the reward-based advertising platform server 10. Alternatively, the rewards system may include a member terminal 20 that is connected to the reward-based advertising platform server 10 via a network or may further include a rewards app that is installed onto both the reward-based advertising platform server 10 and the member terminal 20. The reward-based advertising platform server 10 provides advertising contents from an advertiser to members through a reward app and provides appropriate rewards to members who have accessed the advertising contents.

The member terminal 20 is a mobile terminal to which a rewards app can be installed, and a member is a person who has downloaded the rewards app 400 onto a mobile terminal to join the service. The rewards app 400 is a mobile rewards application that makes profits from mobile app advertising, or more specifically, from the installation, review, and execution of an advertising app by a member. In a sense, a rewards app service reflects the characteristics of a corporation, whereby it rewards a member for work activities therein. That is, the rewards app service makes a virtual organization using the rewards app 400, and rewards members of this virtual organization for work activities. In this regard, the rewards app 400 may be given a corporate name, whereby here we will called it, “Mobile Company.”

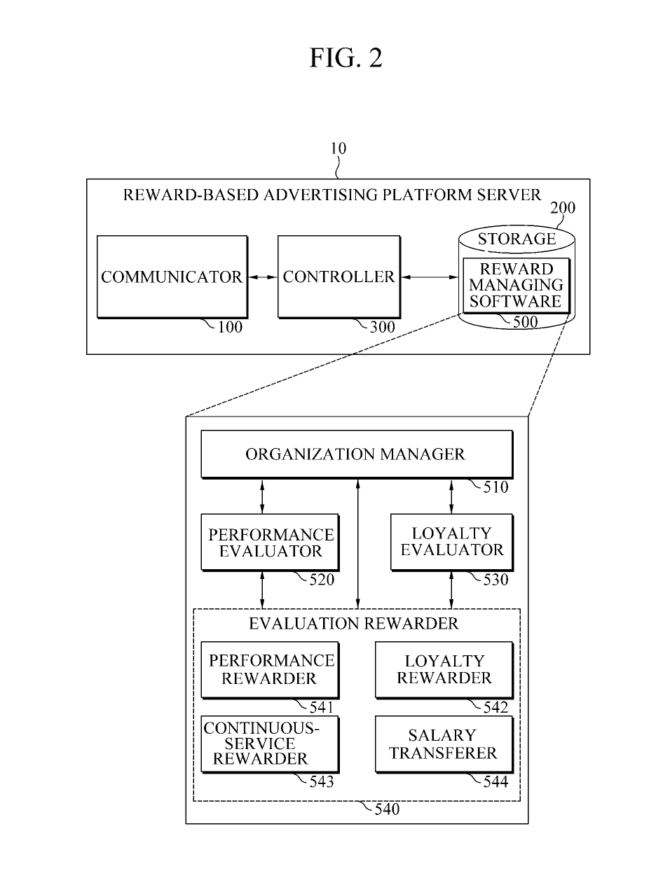

The reward-based advertising platform server 10 manages the virtual organization “Mobile Company”, appoints each member to a hierarchical position, evaluates work activities of each member (employee), and appropriately rewards each member for the work activities. The work activities may be divided into performance-related activities and loyalty-related activities. Performance-related activities are those that directly result in incentives, and loyalty-related activities are those that result in loyalty to “Mobile Company.” The reward-based advertising platform server 10 evaluates each member's work activities, which include performance-related activities and loyalty-related activities, and appropriately rewards each member according to the evaluated results. Detailed descriptions about the reward-based advertising platform server 10 are provided with reference to FIG. 2.

FIG. 2 is a block diagram illustrating a reward-based advertising platform server according to an exemplary embodiment. The reward-based advertising platform server 10 may be a single server, consist of a plurality of servers, or have a distributed system structure. A communicator 100 may include one or more interfaces for connection to an internal network and/or an external network. A storage 200 is a storage medium to house commands, data, and programs. The storage 200 may include one or more memories and store a reward management software 500 that is associated with a rewards app. A controller 300 may include one or more processors and execute the reward management software 500 so that a rewards app service may operate properly. Upon execution thereof, the reward management software 500 is connected to a rewards app stored in a member terminal 20 to transmit and receive data.

The reward management software 500 includes an organization manager 510, a performance evaluator 520, a loyalty evaluator 530, and an evaluation rewarder 540. The organization manager 510 manages an organization and assists activities of members in the organization. The organization manager 510 manages the virtual organization “Mobile Company.” consisting of a plurality of branches. According to the exemplary embodiment, the organization manager 510 may divide the “Mobile Company” into a plurality of regional branches. A member may select a region of choice and be allocated to the pertaining branch. For example, the organization manager 510 divides the “Mobile Company” into 16 branches across the nation and allocates a member to a branch according to a region input by the member. In addition, the organization manager 510 manages the whole organization on a branch unit basis, and manages the organizational structure of each branch. The organizational structure may be classified into 11 grades including a junior employee, a senior employee, an assistant manager, a section chief, a deputy manager, a manager, a director, a managing director, a senior managing director, a vice president, and a president. In the beginning, a member starts out as an intern, not a regular worker, and can later be promoted to a junior employee.

The organization manager 510 may change the number of branches according to the number of members, limit the number of members allocated to each branch, and limit the number of members appointed to each position. For example, the organization manager 510 may start off with having one branch across the nation but will later increase the number of branches to 10 (based on the number of provinces) if the number of members increase. If more members are attracted, the organization manager 510 further increases the number of branches by dividing each province into cities or districts and setting a branch in each city or district, so that each branch may consist of a suitable number of members. The number of members at each position may be limited as shown in Table 1.

TABLE 1

| | Limited Number |
|---|---|
| Position | of Persons |
| President | 1 |
| Vice President | 3 |
| Senior | 5 |
| Managing | |
| Director | |
| Managing | 10 |
| Director | |
| Director | 30 |
| Manager | 50 |
| Deputy | 100 |
| Manager | |
| Section Chief | 300 |
| Assistant | 500 |
| Manager | |
| Senior | 1,000 |
| Employee | |
| Junior | 2,000 |
| Employee | |
| Intern | not limited |

In addition, the organization manager 510 manages an advertising apps list to encourage members to conduct advertising activities. The advertising apps list is a list of applications requested by advertisers, that is, a list of advertising apps. The advertising apps list may include self-advertisements made by the “Mobile Company” and agent advertisements provided by a mobile advertising agent. The organization manager 510 transmits the advertising apps list to the rewards app 400 to provide the same to a member. As a result, the member may conduct advertising activities by selecting a desired advertising app from among the advertising apps list and installing the selected advertising app onto a mobile terminal.

The performance evaluator 520 evaluates the performance of a member based on a performance-related activity criteria. Performance-related activities belonging to the performance-related activity criteria include installing an advertising app and further include either executing or reviewing the installed advertising app, or both. The rewards app 400 provides the advertising apps list, and a member may select an advertising app of choice from among the advertising apps list and download the selected advertising app to be installed. The member may download the advertising app via the app market. Once an advertising app has been installed, the rewards app 400 reports the installation of the advertising app to the reward-based advertising platform server 10. In addition, once the advertising app is executed or reviewed, the rewards app 400 may report the execution or review of the advertising app to the reward-based advertising platform server 10. Furthermore, the performance criteria may also include participation in a survey. A survey may be submitted by any member, and, if a specific member participates in a survey submitted by a different member, the participation is regarded performance of the specific member. Once a member participates in a submitted survey, the rewards app 400 reports the participation to the reward-based advertising platform server 10.

If the performance-related activity criteria include executing an advertising app, then doing so may be regarded as a performance-related activity for a predetermined period of time once to three times a day. By limiting the activity to a certain period of time and the number of times of execution, it aims to prevent reckless accumulation of incentives. In addition, if the performance-related activity criteria include reviewing an advertising app, the review may be authenticated by a capture image. Specifically, a review of an advertising app is beneficial to an advertiser, and a review in the app market may be more beneficial to the advertiser in terms of advertising effects compared to a review in the rewards app 400. In this case, an app review function provided in the app market is used. According to the exemplary embodiment, that the review submission process is as follows: a member submits a review of an advertising app in the app market, captures an image of a screen displaying the review, submits the captured image in the rewards app 400, and posts a reply therein. Of course, the captured image should include not only the review, but also an image or text that identifies the advertising app.

The performance evaluator 520 of the reward-based advertising platform server 10 evaluates the performance of a member according to the member's activities reported by the rewards app 400. According to the exemplary embodiment, the performance evaluator 520 grades the performance of a member once the member's performance-related activity has been confirmed. A different performance grade may be set for each performance-related activity. Specifically, a different performance grade may be set even for the same performance-related activity according to conditions upon which it is set. For example, a different performance grade may be set for a performance-related activity, which may include installing, executing, or reviewing an advertising application, depending on the advertising app or on the advertising fees paid by an advertiser. That is, advertising apps A and B may require different amounts of advertising fees, and performance therein needs to be graded differently. Furthermore, performance may be counted as cash. An amount of incentives may be set for each performance-related activity, and, in this case, the performance evaluator 520 may evaluate the performance of a member by rewarding appropriate incentives corresponding the performance-related activity conducted by the member. Also, if a member submits a review of an advertising app, the performance evaluator 520 may analyze the captured image using a text mining technique, check whether any performance was achieved based on the analytic result, and evaluate the performance.

The loyalty evaluator 530 evaluates loyalty-related activities of a member based on loyalty-related activity criteria. The loyalty-related activity criteria enable the loyalty evaluator 530 to determine each member's loyalty to the “Mobile Company.” Loyalty-related activities belonging to the loyalty-related activity criteria include at least one of confirming attendance, viewing an advertisement, installing an advertising app, executing the installed advertising app, and reviewing the installed advertising application, of which members must meet at least one of these criteria. The criteria also includes at least some of recommending a new member, writing a post in a community, submitting a survey, and participating in a survey, of which some must be met. Confirming attendance refers to the act of executing the rewards app 400 and maintaining the execution of the rewards app 400 on screen for a predetermined period of time (e.g., one minute). Attendance may be confirmed once a day as a loyalty-related activity. Viewing an advertising app refers to the act of selecting a posted web advertisement and viewing the same. Viewing an advertisement may be counted once or a couple of times a day as a loyalty-related activity.

Detailed descriptions about installing an advertising app, executing the installed advertising app, and reviewing the installed advertising app are the same as described above. Recommending a new member refers to the act of recommending the “Mobile Company” to a new person. Using a new member recommending function (friend recommending function) of the rewards app 400, a member is able to recommend the “Mobile Company” to a friend through a SMS/MMS message or a social network service (SNS) messenger. If the friend installs the rewards app 400 and inputs the account information (ID) of the recommended member, the recommendation is confirmed.

A community may be managed on a branch unit basis. The organization manager 510 operates and manages a community for each branch. Members may write and submit a post in the community, which is a virtual space, to which other members may post their replies. Replying to a post may be counted once or a couple of times a day as a loyalty-related activity. In addition, a survey service refers to the act of conducting a survey among members, whereby if a specific member registers a survey, other members are able to participate in the registered survey. Participation in the survey may be counted once to three times a day as a loyalty-related activity, and the number of participants may be limited.

The loyalty evaluator 530 of the reward-based advertising platform server 10 evaluates a member's loyalty according to the member's activities reported by the rewards app 400. A loyalty-related activity may be quantified as appraisal points. Thus, the loyalty evaluator 530 evaluates a member's loyalty by giving appraisal points to the member depending on the loyalty-related activity the member has performed. Depending on the conditions upon which the activities were performed, different appraisal points may be given for different loyalty-related activities and even for the same loyalty-related activities. (For example, depending on an advertising app, different appraisal points may be given for a loyalty-related activity, such as installing, executing, or reviewing an advertising app.

The evaluation rewarder 540 determines and provides a reward according to both a performance evaluation conducted by the performance evaluator 520 and a loyalty evaluation performed by the loyalty evaluator 530. According to the exemplary embodiment, the evaluation rewarder 540 determines a reward by adding extra incentives, which are determined according to the loyalty evaluation performed by the loyalty evaluator 530, to incentives which were determined according to the performance evaluation performed by the performance evaluator 520.

At times, some of the performance-related activities and loyalty-related activities may be the same. Thus, if a member conducts an activity that belongs not only to performance-related activity criteria, but also to loyalty-related activity criteria, the member may satisfy both of groups of criteria by doing the one activity.

The loyalty evaluator 530 gives out appraisal points depending on the loyalty-related activities of the members, determines positions for the members based on the appraisal points, and ranks the members of each position according to the appraisal points they receive. Each member may be appointed to a different position in real time, as rankings of the members change based on the appraisal points they receive. According to the loyalty evaluation performed by the loyalty evaluator 530, members may be given extra incentives, thereby motivating the members to conduct more work activities.

The evaluation compensation component 540 includes a performance-related rewarder 541 and a loyalty-related rewarder 542. The performance-related rewarder 541 determines and provides incentives according to an evaluation on the performance of each member. According to the exemplary embodiment, in a case where there are set incentives for each performance-related activity, the total amount of incentives are determined to be the sum of incentives for performance-related activities. The loyalty-related rewarder 542 determines and provides extra incentives according to the loyalty evaluation performed by the loyalty evaluator 530. The loyalty rewarder 542 determines and provides different incentives for different positions based on the total number of incentives for each branch. According to the exemplary embodiment, the loyalty rewarder 542 determines extra incentives according to the total incentives per day and provides the extra incentives the next day. Even though the number of employees in a branch increases or the daily advertising profits have gone up, the employees may be given allowances in proportion to their positions. Such events may result in a virtuous cycle and have what is called a ‘same-side network effect’, whereby a member may feel grateful for other members' performing more work activities, rather than considering the other members to be competitors.

The loyalty rewarder 542 may determine additional incentives (position-based allowance) that are provided equally for each position which is done by dividing the total amount of extra incentives by the number of positions and then dividing the resultant amount by the number of employees at each position or by the number of employees at each position who are eligible for receiving additional incentives. The total amount of the position-based allowance may be the same as the total amount of incentives, and the position-based allowances may not be provided to interns. Thus, the position-based allowance is provided for employees who are at the 11 positions aforementioned, ranging from junior employees to the president. In addition, as shown in Table 1, the president should be one person, and the limits on numbers of employees appointed to the other positions dramatically increase from a high position to a low position, and so there is a huge gap in position-based allowances between the president and a junior employee. The gap in position-based allowances may bring about a positive effect in that it motivates employees to work more.

In general, the loyalty rewarder 542 provides additional incentives not to every member, but only to members satisfying work requirements (requirements for additional incentives). Here, work requirements may refer to performing a predetermined performance-related activity and/or loyalty-related activity. According to the exemplary embodiment, the work requirements may include at least one of the following: installing an advertising app, reviewing the advertising app, or recommending a new member. Thus, the loyalty rewarder 542 may check whether a member satisfies the work requirements, determine additional incentives corresponding to the member's position, and provide the additional incentives to the member.

Another general aspect is that the loyalty evaluator 530 gives out and accumulates appraisal points for each member, but deducts some of the points the member has accumulated at predetermined time intervals. According to the exemplary embodiment, each day, the loyalty evaluator 530 may deduct appraisal points of a member. For example, the loyalty evaluator 530 may deduct 10% of a member's appraisal points every day. As such, if appraisal points are given out to members according to their loyalty-related activities and then some of those accumulated appraisal points are deducted every day, appraisal points of a member who does not work may be reduced and the member's position may be degraded, and, in turn, the member's position-based allowance will shrink. This kind of appraisal point system has a motivating effect on members, thus encouraging them to work more actively and constantly.

The evaluation rewarder 540 may further include a continuous-service rewarder 543. The continuous-service rewarder 543 provides additional rewards to members who have served for a predetermined period of time. For example, the continuous-service rewarder 543 may determine an additional reward for a member who has served for 100 or more days and provide the additional reward continuously, not once. In a case where a member is still an employee, the continuous-service rewarder 543 determines an additional reward which is given out daily after the 100^{th} day since joining the service and provides the additional daily reward for the member in the form of a retirement package. The additional reward may be equivalent to 10% of the incentives of the member's performance-related activities and may be provided the next day.

According to another general aspect, the evaluation rewarder 540 may further include a salary transferer 544. In a case where a reward is paid by at least one of the performance rewarder 541, the loyalty rewarder 542, or the continuous-service rewarder 543, the salary transferer 544 may transfer the reward to an actual bank account of a member. According to an exemplary embodiment, any member may request for a salary transfer when a reward reaches a specific amount, and determine an amount of money to be transferred. In addition, in response to a request received from the first day and the last day of the month, the salary transferer 544 may transfer the requested reward on a specific date, for example, the 10^{th} day of the month. Via the rewards app 400, the salary transferer 544 receives the member's request for both the amount and transfer of money, information on a bank account, and information on the account holder, which the salary transferer then transfers the amount of money as salary.

The organization manager 510 authorizes board members to monitor and report work activities of members. A board member may be a member appointed as a director or a position higher than a director. According to an exemplary embodiment, the organization manager 510 authorizes a board member to monitor and report any member who does not comply with community rules. A report function may be active in the reward app 400 of board members. Thus, if any member uploads an inappropriate post or survey, a board member may use the report function to report the member to the reward-based advertising platform server 10. Then, a manager may check the report and impose restrictions on the member, for example, deleting or deactivating the member's account. Alternatively, the organization manager 510 may automatically analyze the report using a text mining technique. If the report turns out to be false, the organization manager 510 may impose restrictions on the board member.

The organization manager 510 manages a uniform resource locator (URL) of each advertising app included in an advertising apps list, wherein the URL is required to establish a link connection to the app market so as to download a corresponding advertising app. In the case of installing an advertising app in the rewards app 400, the organization manager 5140 provides an URL of the advertising app beforehand. By receiving the URL from the reward-based advertising platform server 10, the rewards app 400 may move to a corresponding page on the app market. The URL of each advertising app may be the first URL or the second URL. The first URL is for access to a page on which the advertising app is capable of being downloaded, and the second URL is for access to a page that is found after searching the app market for an advertising app with a keyword. The keyword may be provided by an advertiser. The organization manager 510 searches the app market with the keyword, and generates and manages the second URL, which is for access to the found page. The organization manager 510 manages the first URL if there is no keyword for each advertising app, and manages the second URL if there is a keyword for each advertising app. In addition, the organization manager 510 transmits an URL to the rewards app 400. Specifically, the organization manager 510 transmits the second URL if the second URL exists; if not, the first URL is transmitted.

Furthermore, the organization manager 510 manages additional information of an advertising app having the second URL. The additional information indicates the ranking of the advertising app when moving to a page of the app market using the second URL. That is, the additional information is the ranking of the advertising app searched in the app market using a predetermined keyword. The ranking of the advertising app may be an approximation, for example, a figure that ranges between 20 and 30. The organization manager 510 may transmit the ranking to the rewards app 400 along with the second URL, and in addition, the rewards app 400 may display the received ranking to notify a member of the same.

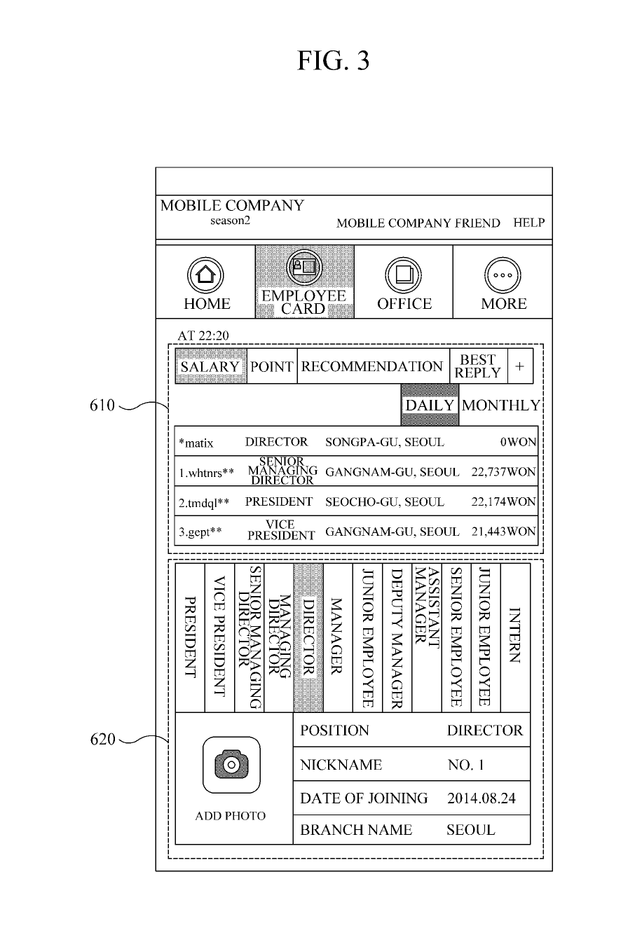

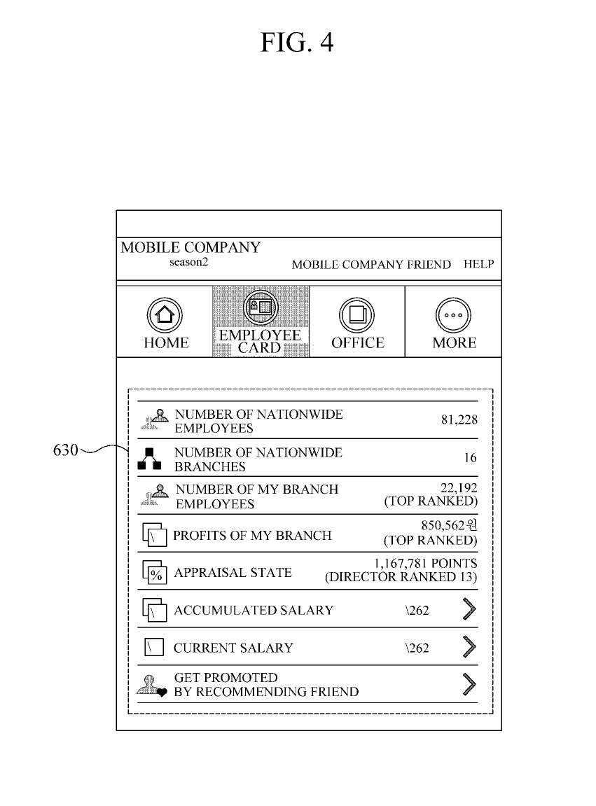

FIGS. 3 and 4 are diagrams illustrating a user interface on which a category “Employee Card” of a rewards app is displayed. As illustrated in FIGS. 3 and 4, categories “Home”, “Employee Card”, and “Office” are displayed on the upper part of the user interface. Following are descriptions about the category “Office.” As indicated by the reference number 620, the all positions are displayed and a position of a member may be highlighted. In addition, the member's position, screen name, sign-up date, and branch name are displayed. The position may be changed in real time according to appraisal points of the member, and the screen name may be used when registering a post/reply in a community. The sign up date refers to the subscription date; furthermore, the branch name indicates the work area that the member chose during the sign-up process.

In addition, as indicated by the reference number 630 in FIG. 4, the “Number of Nationwide Employees”, the “Number of Nationwide Branches”, the “Number of My Branch Employees”, “Profits of My Branch”, “Appraisal State”, “Accumulated Salaries”, “Current Salary”, and “Get Promoted by Recommending A Friend” are displayed. The “Number of Nationwide Employees” indicates the total number of members of “Mobile Company.” The “Number of My Branch Employees” indicates the number of members in an area to which a member belongs. The “Profits of My Branch” indicates the total amount of incentives of all the members in the area to which a member belongs—incentives which are paid according to performance-related activities of the members. The “Appraisal State” indicates appraisal points and the position of a member. The “Accumulated Salaries” indicate the total reward (salary) accumulated through the rewards app 400. The “Current Salary” is an amount of money calculated after deducting the transferred salary from the accumulated salaries. The “Get Promoted by Recommending A Friend” provides a function that enables recommending a friend through a social networking service such as an SNS messenger. If the recommended friend joins and becomes a member, predetermined appraisal points are given to the recommender.

In addition, as indicated by the reference number 610, the ranking about “Salary”, “Points”, “Recommendation”, or “Best Reply” may be provided on a daily or monthly basis. The rankings may be among the members across the nation or in the branch. The reference number 610 indicates an example of the ranking regarding “salary”, and the rankings regarding “Points”, “Recommendation”, or “Best Reply” may be provided in the same way. Members ranked in the top 3 are displayed, but a rankings list may be further displayed in response to clicking “+” placed on the top right side on the screen. For example, upon clicking the “+” button, a list of members ranked in the top 30 may be displayed. For reference, “Points” indicates appraisal points; “Recommendation” indicates recommendation of a friend; and “Best Reply” indicates a reply that has been selected as the best reply for a main post in the community. Although not illustrated in FIGS. 3 and 4, the “Attendance Check” button becomes active on a daily basis after a predetermined period of time has lapsed since the first access, and predetermined appraisal points are given once the attendance is confirmed once the “Attendance Check” button has been pressed. In addition, at least some of information displayed with reference numbers 610, 620, and 630 may be updated in real time by the reward management software 500.

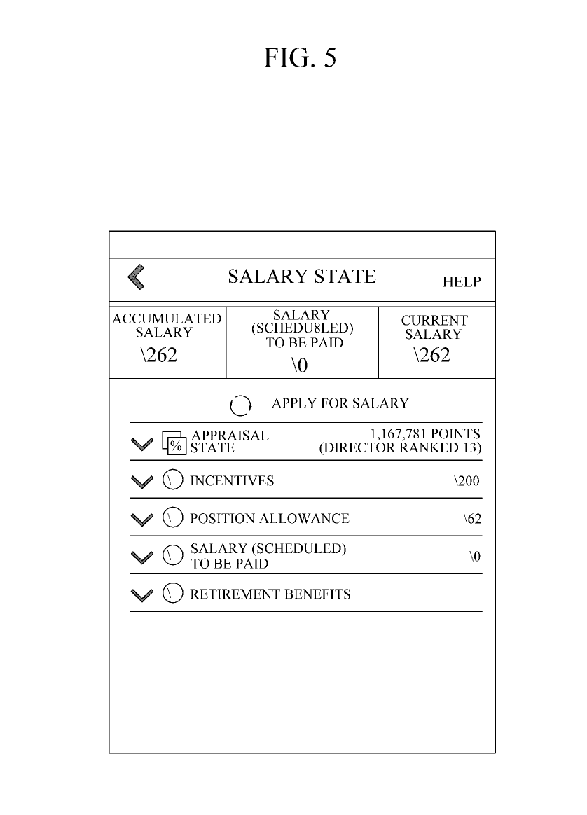

FIG. 5 is a diagram illustrating a user interface showing a salary state according to an exemplary embodiment. If any one of “Appraisal State”, “Accumulated Salaries”, and “Current Salary” is selected in FIGS. 3 and 4, a screen shown in FIG. 5 is displayed. In FIG. 5, “Appraisal State”, “Incentives”, “Position Allowance”, “Salary (Scheduled) To Be Paid”, and “Retirement Package” are displayed, and detailed information on a selected item are further displayed. If “Apply For Salary” is selected, the member is required to enter in a transfer request for an amount of money, a bank name, a bank account, and an account holder. Once the above information have been entered, the salary is transferred to the bank account the next month.

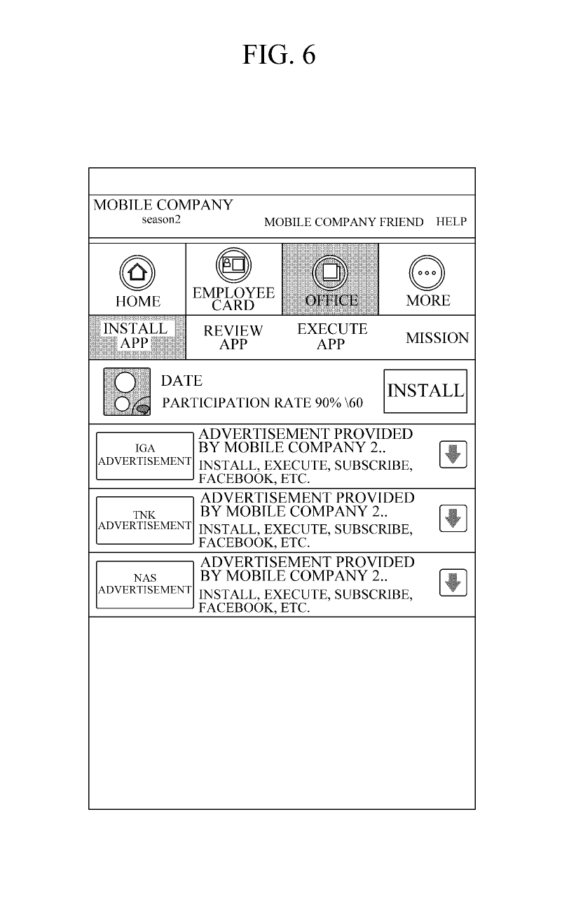

FIGS. 6, 7, and 8 are diagrams illustrating a user interface in a case where the category “Office” of a rewards app has been selected, according to an exemplary embodiment. The category “Office” is the main space for performance-related activities of members. Once the category “Office” has been pressed, an advertising apps list is provided as shown in FIGS. 6, 7, 8, whereby a menu consisting of “Install App”, “Review App”, “Execute App”, and “Mission” is provided; once any one of the options in the menu is selected, an advertising apps list belonging to the selected option is provided. FIG. 6 shows an advertising apps list of advertising apps that are available for installation. As previously described, the organization manager 510 may manage a self-advertising apps list and an agency-advertising apps list, and transmit the self-advertising apps list and the agency-advertising apps list to the rewards app 400. Thus, an advertising app provided through the rewards app 400 may include the self-advertising apps list and the agency-advertising apps list. In FIG. 6, the advertising app “DATE” is a self-advertising app, and an agency-advertising apps list is there below. The agency-advertising apps list may be provided on the basis of advertising agency. In FIG. 6, the agency-advertising apps list consists of advertisements for IGA WORKs (IGA) advertisement, TNK, and Network Advertising System (NAS). The IGA advertisement agency advertisement of IGA WORKs Company; the TNK advertisement indicates an agency advertisement of TNK; and the NAS advertisement indicates an agency advertisement of NAS.

Once the “Install” button of the advertising app “DATE” has been pressed, the rewards app 400 takes the user to the app market using an URL that is provided by the reward-based advertising platform server 10. If the URL at this time is the first URL, the rewards app 400 moves directly to a download page for the app “DATE”; if it is the second URL, the rewards app 400 moves to a page that is found after searching the app market with a keyword related to the app “DATE.” In this case, a member may find and select the app “DATE” in the found page that displays results for the search, whereby the member is then taken to a download page for the app “DATE” so as to download and install the same.

The second URL, which is necessary to establish a link to a page displaying search results for a keyword, is provided to increase profits of an advertiser. The app market manages a rankings list of similar apps based on keywords that have been searched. For example, the app “DATE” may be ranked and listed as number one if a search in the app market for the keyword “Blind Date” had been performed but may be ranked and listed 50^{th} if the search were under the keyword “Meeting”. As such, the advertiser would want the app “DATE” to be highly ranked even when a search is performed using the keyword “Meeting.”

The organization manager 510 manages the app “DATE” associated with the keyword “Meeting”, and manages the second URL that leads to a search result page obtained by searching the app market for the keyword “Meeting.” Then, the organization manager 510 provides the second URL to the rewards app 400. According to an exemplary embodiment, if a member requests installation of the app “DATE,” the organization manager 510 provides the second URL to the rewards app 400 to thereby move to a search result page obtained by searching the app market for the keyword “Meeting.”

If the app “DATE” is ranked relatively lower on the search result page, it is hard for a member to find the app “DATE” immediately. Thus, the rewards app 400 may provide the ranking of the app “DATE” in the form of a pop-up window for the member's convenience. As described above, the rewards app 400 receives the ranking from the reward-based advertising platform server 10. The ranking of the app “DATE” may be provided to the member before or after moving to the search result page. As a result, the member may find the app “DATE” quickly due to the ranking information.

By doing so, the ranking of the app “DATE” may go up in a case where a search on the app market for the keyword “Meeting” is performed. Establishing a link to a search result page may be limited only to self-advertisements or both self-advertisements and agency-advertisements. This kind of keyword searching service may be applied in any situation that involves installing an app. For example, for the “Review App”, an application needs to be installed beforehand, thus enabling the establishment of a link to a search page.

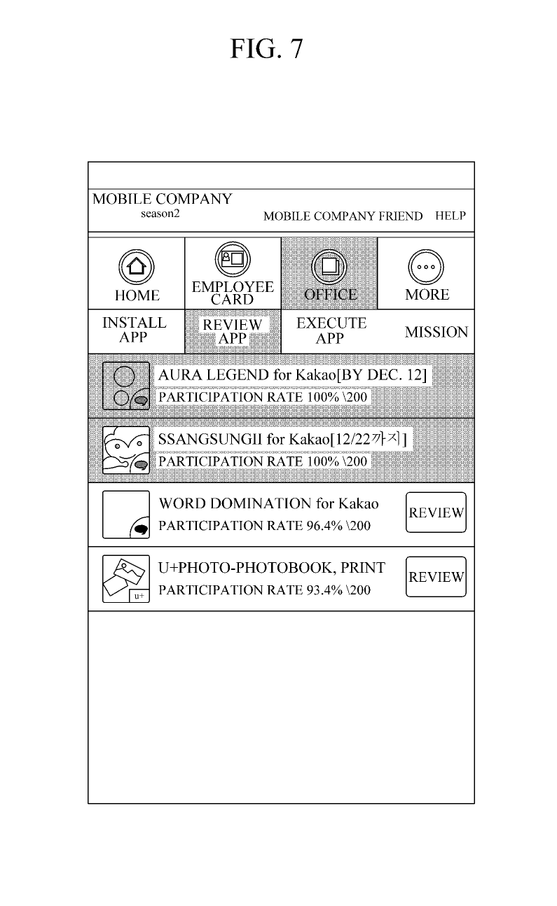

FIG. 7 shows an advertising item list in a case when “Review App” has been selected. When a review is written of an app that has been installed via the app market, incentives and appraisal points are accumulated. A review may be written according to the following steps: an app is installed via the app market by pressing the “Write review”; the review is written with a star rating after the installation is complete, and a screen displaying the review is captured. Once the captured image is registered in “Review app” of the option “Office”, the server accumulates incentives and appraisal points within 24 hours after the review is confirmed. Advertising fees may be accumulated as incentives in the salary, and an amount of appraisal point equivalent to 30 times the advertising fees may be accumulated as appraisal points. In the server, the review may be confirmed manually by a manager or may be confirmed automatically using a text mining technique, and upon inspection as to the nature of the review—whether or not the review has any malicious intentions—the server may accumulate incentives and appraisal points. That is, incentives and appraisal points are not necessarily accumulated for every app review.

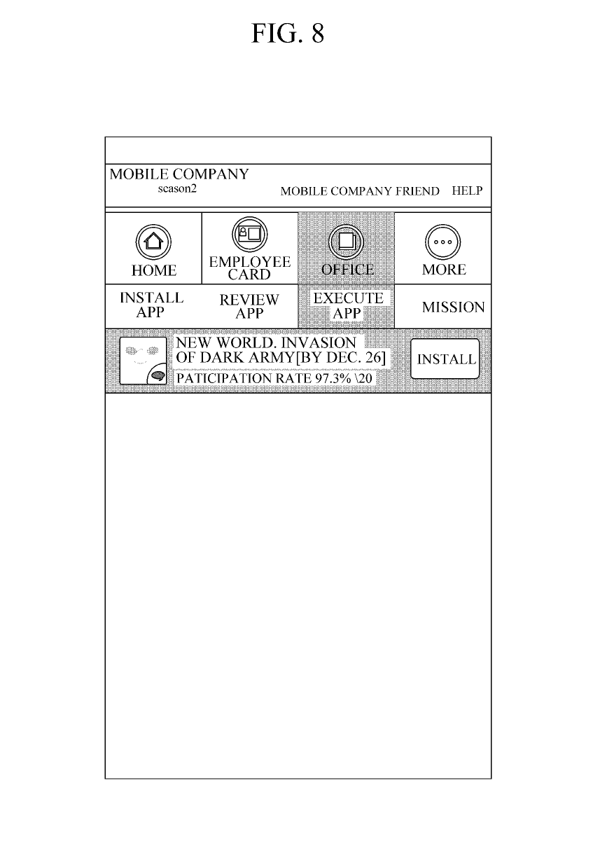

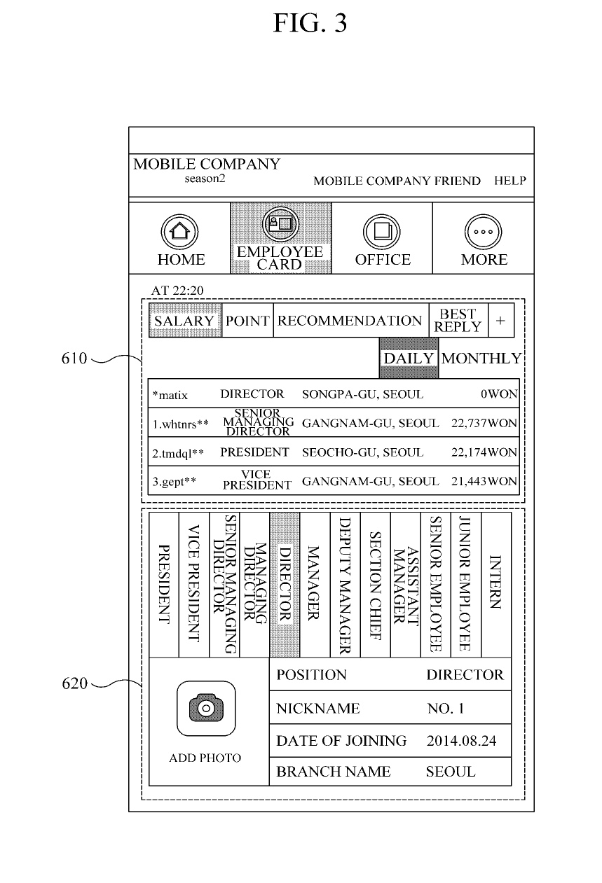

FIG. 8 illustrates an advertising item list for “Execute App”. An app is installed via the app market, and incentives and appraisal points are accumulated each time the installed app is executed. The incentives and the appraisal point are accumulated at a certain point in time every day for a predetermined period of time. An app may be executed as follow: the app is installed via the app market by pressing the button “Install”, and incentives and appraisal points are accumulated by pressing the button “Execute” in the “Execute App” after the installation is complete. The reason that reward for executing the app is given not once but repeatedly is not only to provide monetary incentives to a member at each execution of the app, but also to give appraisal points to the member. By doing so, even in a case where the monetary incentives are relatively insufficient, the member may get promoted based on the appraisal points and thus may be rewarded with a position allowance corresponding to the newly appointed position.

Although not illustrated in FIG. 8, “Mission” on the menu gives a specific mission to a member, and rewards the member with incentives and appraisal points if the member completes the mission. With respect to the “mission”, the member may be rewarded with appraisal points as well as incentives. Furthermore, although not illustrated in FIG. 8, the category “Home” of the rewards app 400 may consist of an advertising area, a shopping area, a survey area, and a community area. The advertising area is an area for providing mobile web advertisements about social commerce, open market, shopping malls, and the like. Appraisal points are given upon pressing a mobile web advertisement, for which appraisal point are given up to three times a day. Limiting the number of times appraisal points are given aims to prevent members from receiving appraisal points limitlessly simply by viewing the advertisement. The shopping area is an area for providing an advertisement about Internet stores, such as G Market, 11^{th} St, Ticketmonster, Coupang, and other online stores specialized for men, women, and kids. With respect to the shopping area, a specific percentage of a purchase amount is accumulated as points. It is because there may be no limit in the number of members in an online store and it might cause the company to pay fees in proportional to the number of members.

The survey area is an area for registering and participating in a survey. A member is able to register a survey and other members may participate in the registered survey. Participation in a survey may be compensated with incentives and/or appraisal points. Registering a survey may be compensated with appraisal points while deducting a reward, a process which is performed by the performance evaluator 520 and the loyalty evaluator 530. As such, once a member registers a survey, the performance evaluator 520 deducts a reward, and the loyalty evaluator 530 may raise appraisal points. The community area is an area for members to conduct community activities with employees. The community area is different from any other community in that a member writing a main post or reply may be given appraisal points. In addition, the best reply may be selected either randomly or by the writer of the main post from among a plurality of replies, and to this best reply, an additional appraisal point is given. However, only one best reply may be selected on a daily basis by the writer of a main post to prevent reckless provision of appraisal points. In addition, a board member may be authorized to monitor and report either survey activities or community activities of members. Therefore, the survey and/or community may be managed and maintained by members without a monitoring service provided by a server.

A performance-related activity conducted in an additional application associated with an account of a member is considered by the performance evaluator 520 as a performance-related activity of the member, while a loyalty-related activity conducted in the associated application is considered by the loyalty evaluator 530 as a loyalty-related activity of the member. For example, an associated application may be installed in a mobile device of a person in a close relationship to a pre-existing member, such as a friend, a parent, or an acquaintance. In this case, if a member's account information is entered into the associated application, performance-related and/or loyalty-related activities conducted in the associated application are considered as performance-related/loyalty-related activities of the member. The associated application may be named “Mobile Company Friend” App, and may provide only some functions of the rewards app 400. For example, the “Mobile Company Friend” app may provide functions related only to advertising activities, like those of installing, reviewing, and executing an app.

By not only rewarding members for performance related to advertising activities, but also giving appraisal points for loyalty, it is possible to reinforce solidarity and loyalty of members.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for rewarding economic activities in a virtual space using a reward-based mobile advertising application, wherein a virtual organization is made up of members to the reward-based mobile advertising application and the economic activities are conducted by the members, the system comprising:
an organization manager configured to form the virtual organization with a plurality of branches, manage the virtual organization and an organizational structure on a branch unit basis, change a number of branches according to the number of members, limit a number of members belonging to each branch, and limit a number of members at each position;
a performance evaluator configured to evaluate performance of the members based on a performance-related activity criteria that comprises at least one of installing an advertising app, executing the installed advertising app, or reviewing the installed advertising app;
a loyalty evaluator configured to evaluate loyalty of the members based on a loyalty-related activity criteria comprising at least one of the following: attendance, viewing an advertisement, installing an advertising app, executing the installed advertising app, or reviewing the installed advertising app and at least some of the following: recommending a new member, posting in a community, registering a survey, or a replying to a post; and
an evaluation rewarder configured to reward each member according to a result of the evaluated performance and loyalty thereof.

2. The system of claim 1, wherein the reviewing of the installed advertising app is confirmed with a capture image.

3. The system of claim 1, wherein the loyalty evaluator is further configured to give appraisal points to the members according to the loyalty-related activities thereof, determine hierarchical positions of the members according to the appraisal points, and rank members who are in the same positions according to the appraisal points.

4. The system of claim 3, wherein the evaluation rewarder is further configured to comprise:
a performance rewarder configured to provide a member with incentives each time a performance-related activity of the member is confirmed; and
a loyalty rewarder configured to provide additional incentives differently according to a total amount of incentives of each branch, wherein the additional incentives of each branch is provided to members differently according to positions thereof.

5. The system of claim 4, wherein the loyalty evaluator is further configured to accumulate the appraisal points and deduct some of the appraisal points at predetermined time intervals.

6. The system of claim 4, wherein the loyalty rewarder is further configured to provide the additional incentives according to a total amount of incentives earned on a daily basis, wherein the additional incentives are provided only when requirements for additional incentives are satisfied.

7. The system of claim 4, wherein the loyalty rewarder is further configured to divide the total amount of incentives of each branch into a number of positions and divide an amount of incentives for each position by a number of members in the same position so that the members in each position are provided with an equal amount of incentives.

8. The system of claim 1, wherein the organization manager is further configured to authorize board members to monitor and report loyalty-related activities of the members.
